(19) United States
(12) Patent Application Publication
(10) Pub. No.: US 2007/0224572 A1
(43) Pub. Date: Sep. 27, 2007

(54) Device for Stimulating Gum Using Low Frequency

(76) Inventor: On-Kuk Jon, Seoul (KR)

Correspondence Address: IPLA P.A., 3580 WILSHIRE BLVD., 17TH FLOOR, LOS ANGELES, CA, 90010, US

(21) Appl. No.: 11/570,764

(22) PCT Filed: Jun. 23, 2005
(86) PCT No.: PCT/KR05/01953

§ 371 Date: Dec. 15, 2006

(30) Foreign Application Priority Data
Jun. 25, 2004 (KR) 20-2004-0018130

(51) Int. Cl. A61C 3/00

(52) U.S. Cl. 433/32

(57) ABSTRACT

A device for stimulating a gum using a low frequency is disposed. The gum stimulation is performed in such a manner that a conductive silicon electrode pad formed in a mouthpiece shape closely contacting with a gum is connected, and low frequency stimulation is provided to a gum for thereby enhancing a blood circulation at a gum and releasing a certain pain at a gum, so that a gum can be health. The device for stimulating gums using a low frequency comprises a connection cable for transferring a low frequency current generated by the low frequency generator to the electrode pad, and a connection terminal formed at one side of the electrode pad and connected with the connection cable.

### TECHNICAL FIELD

The present invention relates to a low frequency stimulator capable of enhancing a blood circulation at gums, and in particular to a device for stimulating gums using a low frequency which is capable of enhancing a blood circulation at gums and releasing a certain pain at a gum using a low frequency stimulation more efficiently and easily as compared to a known massage method, etc.

### BACKGROUND ART

According to the Korean patent application No. 1998-020204, when massaging gums, the circumferential surfaces of upper and lower lips are softly touched for thereby stimulating gums and enhancing a blood circulation at a gum using a certain shaped stick, holding with four fingers excluding a thumb.

In addition, according to the Korean utility model No. 1996-0022498, a gum massage method is disclosed. In this method, water is sprayed to a gum with a high pressure using a certain tool like a tooth brushing machine for thereby massaging gums.

However, in the Korean patent application No. 1998-020204, the user may feel tedious because hands or a certain tool are used. It is inconvenient to use the above apparatus and is not efficient. In addition, in the massaging method using high-pressure water of the Korean utility model No. 1996-0022498, the place for massaging a gum is very limited. It is impossible to continuously the above method because water is used.

Namely, a few devices for stimulating a gum using a low frequency are known and have been commercially available. However, there are not any devices that adapt an electrode pad for stimulating a gum.

### DISCLOSURE OF INVENTION

### Technical Problem

Accordingly, it is an object of the present invention to overcome the above-described problems encountered in the conventional art.

It is another object of the present invention to provide a device for stimulating gums using a low frequency in such a manner that an electrically conductive silicon electrode pad formed in a mouthpiece shape closely contacting with a gum is connected, and low frequency stimulation is provided to a gum for thereby enhancing a blood circulation at a gum and releasing a certain pain at a gum, so that a gum can be health.

### TECHNICAL SOLUTION

To achieve the above objects, in a low frequency stimulator formed of a low frequency generator and an electrode pad, there is provided a device for stimulating gums using a low frequency comprising a connection cable for transferring a low frequency current generated by the low frequency generator to the electrode pad, and a connection terminal formed at one side of the electrode pad and connected with the connection cable, wherein the electrode pad is formed in a mouthpiece shape and is formed of an electrically conductive silicon material capable of transferring a low frequency current received through the connection terminal.

In addition, an inner side (portion contacting with an outer side of a gum) of the electrode pad is formed of a conductive silicon pad, and an outer side (portion contacting with an inner side of a lip) of the same is formed of a non-conductive silicon pad.

In addition, in the electrode pad, the non-conductive silicon pad is formed with a V-shaped cross section so that teeth can be inserted into the V-shape of the non-conductive silicon pad, and the conductive silicon pad is attached at an inner side of the V-shaped non-conductive silicon pad in which the gums are positioned when in use.

In addition, the electrode pad has a certain size so that the mouthpiece shaped non-conductive silicon pad 6 concurrently covers the upper and lower sides of the gums, and the conductive silicon pad is attached to the upper and lower sides of the non-conductive silicon pad corresponding to the gums when in use.

### BRIEF DESCRIPTION OF THE DRAWINGS

The present invention will become better understood with reference to the accompanying drawings which are given only by way of illustration and thus are not limitative of the present invention, wherein;

FIG. 1 is a view illustrating a construction of a device for stimulating gums using a low frequency according to the present invention;

FIG. 2 is a perspective view illustrating an electrode pad in which the portions closely contacting with the inner sides of lips and the outer sides of gums are formed of a conductive silicon material according to the present invention;

FIG. 3 is a perspective view illustrating an electrode in which a portion closely contacting with an outer side of a gum is formed of a conductive silicon material according to an embodiment of the present invention;

FIG. 4 is a perspective view illustrating a V-shaped electrode pad based on the shape of teeth according to an embodiment of the present invention;

FIG. 5 is a perspective view illustrating an electrode pad capable of concurrently covering the upper and lower portions of an outer side of a gum according to an embodiment of the present invention; and

FIG. 6 is a view illustrating a wearing state of the device of FIG. 5.

### MODE FOR THE INVENTION

The device for stimulating a gum using a low frequency according to a preferred embodiment of the present invention will be described with reference to the accompanying drawings.

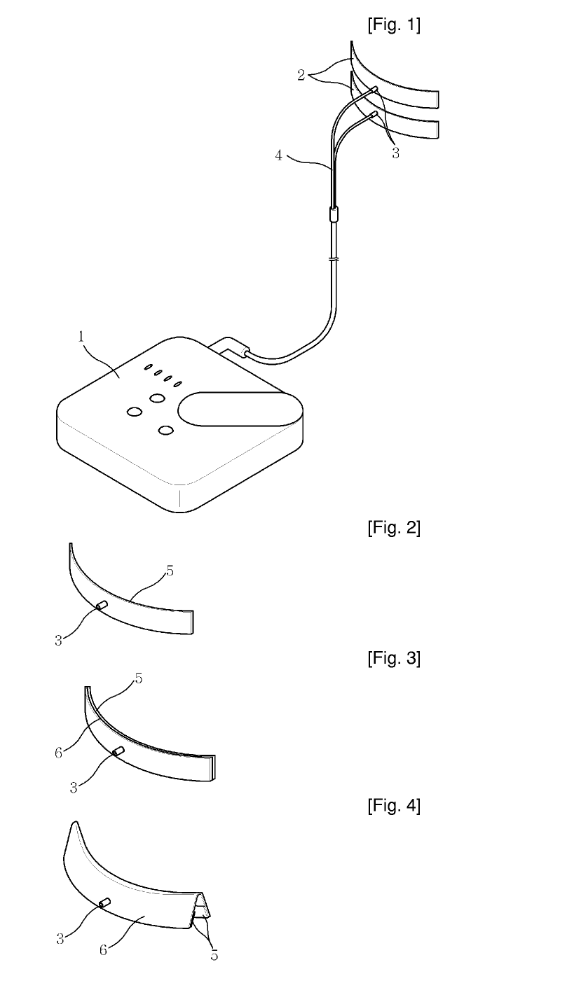

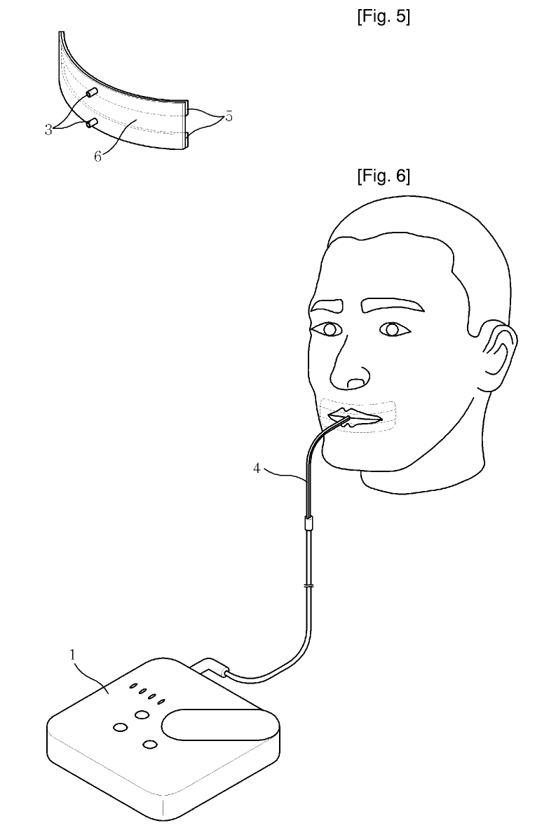

FIG. 1 is a view illustrating a construction of a device for stimulating gums using a low frequency according to the present invention, and FIG. 2 is a perspective view illustrating an electrode pad in which the portions closely contacting with the inner sides of lips and the outer sides of gums are formed of a conductive silicon material according to the present invention, and FIG. 3 is a perspective view illustrating an electrode in which a portion closely contacting with an outer side of a gum is formed of a conductive silicon material according to an embodiment of the present invention. In addition, FIG. 4 is a perspective view illustrating an electrode pad in which the portions closely contacting with the inner and outer portions of a gum are formed of a conductive silicon material, with teeth being inserted into an intermediate portion of a V-shaped pad. FIG. 5 is a perspective view illustrating an electrode pad in which the upper and lower portions of an outer side of a gum are covered by one non-conductive silicon pad, and the portions closely contacting with the upper and lower portions of an inner side of a gum are formed on a conductive silicon material.

As shown in FIG. 1, a low frequency stimulator for a gum includes a low frequency generator 1, a connection cable 4 for transferring a low frequency current generated by the low frequency generator 1, a connection terminal 3, with the connection cable 4 being inserted into one side of the connection terminal 3, and an electrode pad 2 which is formed of a conductive silicon material in a mouthpiece shape.

With the above construction, the low frequency current generated by the low frequency generator 1 is transferred to a gum through the connection cable 4, the connection terminal 3 and the mouthpiece-shaped electrode pad 2 which is formed of a conductive silicon material. At this time, since the mouthpiece-shaped electrode pad 2 is softly and tightly contacted with the gum, the low frequency current effectively stimulates the gum without any pain when the low frequency current is applied to the gum.

FIG. 2 is a perspective view illustrating a mouthpiece shaped electrode pad of which both sides are formed of a conductive silicon material. As shown therein, the both sides of the mouthpiece shaped electrode pad 2 are formed of a conductive silicon pad 5. Therefore, when a low frequency is generated in a state that the electrode pad 2 is inserted between the inner side of the lip and the outer side of the gum, the low frequency transferred to the electrode pad 2 stimulates the inner side of the lip and the outer side of the gum.

FIG. 3 is a perspective view illustrating a mouthpiece shaped electrode pad of which only one side is formed of a conductive silicon material. As shown therein, a conductive silicon pad 5 is formed at an inner side (portion contacting with an outer side of the gum) of the electrode pad 2. An outer side (portion contacting with an outer side of the gum) is formed on a non-conductive silicon pad 6 with the conductive silicon pad 5 and the non-conductive silicon pad 6 being integrally formed. In addition, the connection terminal 3 is connected with the conductive silicon pad 5 through the non-conductive silicon pad 6.

Therefore, when a low frequency is generated in a state that the electrode pad 2 is inserted between the inner side of the lip and the outer side of the gum, the low frequency current transferred to the electrode pad 2 is transferred to only the conductive silicon pad 5 positioned at the outer side of the gum for thereby stimulating the outer side of the gum.

FIG. 4 is a perspective view of the V-shaped electrode pad according to the present invention. As shown therein, in the mouthpiece shaped electrode pad 2, a non-conductive silicon pad 6, with teeth being inserted at the intermediate portion of the same, is formed in a V-shape, and the conductive silicon pad 5 is attached at an inner side of the V-shaped non-conductive silicon pad 6. In addition, the connection terminal 3 is connected with the conductive silicon pad 5 through the non-conductive silicon pad 6.

When the V-shaped electrode pad 2 is inserted like covering the teeth, the conductive silicon pad 5 is positioned at the inner and outer sides of the gum. In this state, when a high frequency current is generated, the low frequency current transferred to the electrode pad 2 is transferred to only the conductive silicon pad 5 positioned at the inner and outer sides of the gum for thereby stimulating all sides of the gum.

FIG. 5 is a perspective view illustrating an electrode pad capable of concurrently stimulating the upper and lower sides of the gum. FIG. 6 is a view illustrating a wearing state of a device for stimulating a gum using a low frequency according to the present invention. As shown therein, the non-conductive silicon pad 6 has a certain size capable of concurrently covering the upper and lower sides of the gum in a mouthpiece shape. When the device is worn to operate at the upper and lower sides of the non-conductive silicon pad 6, the conductive silicon pad 5 is attached to the portions corresponding to the gum. Here, the connection terminal 3 is connected with the conductive silicon pad 5 through the non-conductive silicon pad 6.

Therefore, as shown in FIG. 6, when the mouthpiece shaped electrode pad 2 is inserted between the lip and the gum, the conductive silicon pad 5 is positioned at the outer side of the lower gum. In this state, when a low frequency current is generated, the low frequency transferred to the electrode pad 2 is transferred to the conductive silicon pad 5 positioned at the outer side of the gum for thereby stimulating the outer sides of the upper and lower gums.

### INDUSTRIAL APPLICABILITY

As described above, the device for stimulating a gum using a low frequency according to the present invention is formed in a mouthpiece shape, so that it is possible to effectively and easily stimulate gums based on a low frequency stimulation method. Therefore, a blood circulation at the gums is enhanced, and healthy gums are obtained. It is possible to effectively release a certain pain at gums due to a certain disease.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. In a low frequency stimulator formed of a low frequency generator 1 and an electrode pad 2, a device for stimulating gums using a low frequency, comprising:
a connection cable 4 for transferring a low frequency current generated by the low frequency generator 1 to the electrode pad, and a connection terminal 3 formed at
one side of the electrode pad 2 and connected with the connection cable, wherein said electrode pad 2 is formed in a mouthpiece shape and is formed of a conductive silicon material capable of transferring a low frequency current received through the connection terminal 3.

2. The device of claim 1, wherein an inner side (portion contacting with an outer side of a gum) of the electrode pad 2 is formed of a conductive silicon pad 5, and an outer side (portion contacting with an inner side of a lip) of the same is formed of a non-conductive silicon pad 6.

3. The device of claim 1, wherein in said electrode pad 2, the non-conductive silicon pad 6 is formed with a V-shaped cross section so that teeth can be inserted into the V-shape of the non-conductive silicon pad 6, and the conductive silicon pad 5 is attached at an inner side of the V-shaped non-conductive silicon pad 6 in which the gums are positioned when in use.

4. The device of claim 1, wherein said electrode pad 2 has a certain size so that the mouthpiece shaped non-conductive silicon pad 6 concurrently covers the upper and lower sides of the gums, and the conductive silicon pad 5 is attached to the upper and lower sides of the non-conductive silicon pad 6 corresponding to the gums when in use.
